(19) United States
(12) Patent Application Publication
(10) Pub. No.: US 2022/0225585 A1
(43) Pub. Date: Jul. 21, 2022

(54) TREE WATERING AND FERTILIZING APPARATUS

(71) Applicant: Hassan Hamza, Canoga Park, CA (US)

(72) Inventor: Hassan Hamza, Canoga Park, CA (US)

(21) Appl. No.: 17/152,684

(22) Filed: Jan. 19, 2021

(51) Int. Cl. A01G 29/00; A01G 27/02

(52) U.S. Cl. CPC A01G 29/00; A01G 27/02

(57) ABSTRACT

The present invention relates to a tree watering and fertilizing apparatus that can be used to irrigate and fertilize the base of a tree and to protect the roots thereof. The present invention comprises a tree ring having a bottom half that serves as a root harrier and a top half that serves as a barrier to retain water around a tree while the water percolates to the root system of the tree. An inlet fitting is attached to a water supply and directs water into an irrigation valve that is in fluid communication with a fertilizer dispenser. As the water flows through the irrigation valve and out a distribution fitting, the water flow siphons fertilizer from the fertilizer dispenser and mixes it with the water before it is released through a distribution fitting to irrigate the base of a tree or shrub.

### FIELD OF THE INVENTION

The present invention relates generally to the field of tree watering and fertilizing devices. More specifically, the present invention relates to a tree watering and fertilizing apparatus that can be used to irrigate and fertilize the base or a tree or shrub.

### DESCRIPTION OF PRIOR ART

Sprinklers are a common tool to irrigate lawns and other vegetation. In light of drought conditions throughout some parts of the world, overwatering may be environmentally harmful and costly. Even more, overwatering may lead to fungus or insect infestations. Conversely, underwatering may lead to damage or dry vegetation and trees. This especially poses a problem for trees or shrubs which may require varying watering needs compared to nearby vegetation. Supplying the proper amount of water to trees can be challenging, given the varying sizes and shapes of trees and the close proximity to other plants or trees requiring less water. Some are wide, requiring the sprinkler to be repositioned multiple times to evenly water the surrounding ground. Some are in a slope that allows the water to flow away from the tree.

Sprinklers, especially rotary and oscillating sprinklers, are generally designed to shoot volumes of water in both an upward and outward pattern in order to cover large areas. Often, this method of watering sprays water on the fruit and leaves of trees and shrubs increasing risk of fungal diseases. A soaker hose is another popular method to water a tree. However, a soaker hose is difficult and time consuming to unwrap and place around a tree. Removal of the soaker hose may be necessary every time the grass around the tree will be mowed because the soaker hose can get caught in the mower blades. The grass and other vegetation around the tree can also be damaged if the soaker hose is left for an extended period of time as it can leave an imprint on the grass, sand, or vegetation. Yet another method of watering trees is a low volume drip/sprinkler system. These typically involve long, thin, plastic tubing lying within the landscape that can be crushed or severed if ran over by a mower. Additionally, another way of watering a tree is by manual hosing which can be wasteful, time consuming, and often forgotten.

Even more, the number of devices specifically designed to both water and fertilize a tree is substantially less than devices that merely water. There are a number of systems designed to water trees in the prior art. Previous attempts have proven ineffective and unsuccessful. U.S. Pat. No. 6,601,339 teaches a system with a base which has a periphery and a central hole with a slot in between and interior and exterior walls that extend upwardly from the base. U.S. Pat. No. 5,117,582 teaches a tree irrigator utilizing a flexible tree encircling container which may receive a substantial volume of a tree irrigating liquid and which will slowly disperse the liquid to the tree over a period of time. U.S. Pat. No. 6,023,883, teaches a drip irrigator Which is fitted around the trunk of a tree and holds a supply of water which slowly percolates into the soil to maintain irrigation of the tree roots, particularly during hot and dry weather. A tree surrounding ring for protecting the trunk of a tree and enhancing the appearance of the tree is taught in U.S. Pat. No. 2,782,561. The ring is interrupted by a ring slot or formed from two semicircular sections to facilitate fitting the ring around the trunk of the tree. U.S. Pat. No. 4,010,898 teaches an apparatus that includes a semi-permanent, semi-looped elastic distributing conduit having a closed end and an open end, with a plurality of spray nozzles. U.S. Pat. No. 5,285,968 teaches a water chamber in the form of an annulus having a large open segment which permits the chamber to serve as a yoke which can be positioned on the ground surrounding the trunk of small trees at the base of the trunk. The chamber is continuously fed with water from a garden hose and the wall of the chamber is pierced with a single row of water orifices which are distributed along a line around the upper, outer diameter of the annular body. This arrangement permits the watering of a tree outward, around the drip-line beneath the tree's outer foliage. However, the number of devices that both water and fertilize a tree are less and include U.S. Pat. No. 5,193,306 which teaches a reservoir container that water and a bag of fertilizer. Thus, the water is mixed with the fertilizer and feeds the tree or plant. U.S. Pat. No. 10,617,073 teaches a self-watering planter that allows fertilizer or plant food material to wick into the water as the water is fed into the plant.

Therefore, there exists a need for a tree irrigator which will overcome the deficiencies of the prior art devices without having its own drawbacks. The tree watering apparatus of the present invention provides a practical and satisfactory device which is a significant advance in the art.

### BRIEF SUMMARY OF THE INVENTION

Accordingly, the present invention has been made in view of the above-mentioned disadvantages occurring in the prior art, and it is the object of the present invention to provide a tree watering apparatus that irrigates and fertilizes a tree.

It is another object of the present invention to provide a tree watering and fertilizing apparatus with some rigidity for durability and that is not damaged easily by blades from a mower, tree cutter, or other gardening tools.

It is yet another object of the present invention to provide a tree wat and fertilizing apparatus that incorporates a root barrier that protects the roots of the tree and directs them in a downward direction away from the surface of the ground.

It is yet another object of the present invention to provide a tree watering and fertilizing apparatus that maintains the irrigation water around the tree until it is absorbed by the ground around the base of the tree rather than allowing the irrigation water to flow away from the tree.

It is yet another object of the present invention to provide a tree watering and fertilizing apparatus that allows control over the flow rate or amount of water irrigated around a tree.

It is yet another object of the present invention to provide a tree watering apparatus to which other accessories can be incorporated, such as a landscape light.

It is yet another object of the present invention to provide a tree watering apparatus that is cost effective and manufacturable.

To accomplish the above objects, the present invention is embodied in a tree watering and fertilizing apparatus comprising a tree ring, a fertilizer dispenser, an inlet fitting, an irrigation valve, and a fertilizer valve. Water supply is attached to the inlet fitting to allow water to flow into the apparatus and out a distribution fitting. The fertilizer dispenser is in fluid communication with the distribution hole so as to allow fertilizer to be syphoned and mixed into the water as it is dispensed on the tree. The tree ring partly buried into the ground around the base of the tree so that the water dispensed through the distribution hole irrigates the base of the tree. Furthermore, the bottom section of the tree ring is buried into the ground far enough to protect the roots of the tree and direct their growth downward and away from the ground surface.

The above and other features and advantages of the present invention, as well as the structure and usage of various embodiments of the present invention, are described in detail below with reference to the accompanying drawings.

### DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functional similar elements. A more complete appreciation of the invention and many of the attendant advantages thereof will be readily obtained as the same becomes better understood by reference to the following detailed description considered in connection with the accompanying drawings, wherein:

FIG. 1 shows a perspective view of the tree watering and fertilizing apparatus according to the present invention as it is used around a tree or shrub;

FIG. 2 shows an exploded view of a section of the tree watering and fertilizing apparatus according to the present invention;

FIG. 3 shows a top perspective view of the tree watering and fertilizing apparatus according to the present invention;

FIG. 4 shows a perspective view of the fertilizer dispenser as used in the tree watering and fertilizing apparatus according to the present invention;

FIG. 5 shows a perspective view of the irrigation valve that connects to the tree ring of the tree watering and fertilizing apparatus according to the present invention;

FIG. 6 shows a cross-sectional view of a section of the tree watering and fertilizing apparatus according to the present invention.

FIG. 7 shows a close-up view of the irrigation valve as it is assembled into the tree watering and fertilizing apparatus according to the present invention.

### DETAILED DESCRIPTION OF THE INVENTION

Certain terminology is used in the following descriptions for convenience only and is not limiting. The words “right”, “left”, “lower”, and “upper” designate directions in the drawings to which reference is made. The words “inwardly” or “distally” and “outwardly” or “proximally” refer to directions toward and away from, respectively, the geometric center or orientation of the device and instruments and related parts thereof. The terminology includes the above-listed words, derivatives thereof, and words of similar import.

Although the present invention can be used in connection with any type of irrigation application, it is especially suited for irrigation applications in connection with trees and shrubs. Accordingly, the present invention will be described herein with reference to tree irrigation applications. However, the preferred system of the present application may also be adapted for use on lawns, or flower applications.

Reference will be made to the drawings in which various elements of the present invention will be given numerical designations and in which the invention will be discussed so as to enable one skilled in the art make and use the invention.

The present invention comprises a tree watering and fertilizing apparatus 100 that is placed around the base of a tree and comprising a tree ring 10, a fertilizer dispenser 20, a fertilizer valve 30, an irrigation valve 40, an inlet fitting 50, and a distribution hole 60. It is well-established that the preferred method of watering a tree is at the base spread over a large area around the base of the tree without irrigating the fruits or leaves growing from the branches of the tree. Such method of irrigation ensures that the water is spread around the tree so as to encourage root growth in all directions. The tree watering and fertilizing apparatus 100 of the present invention is partly buried into the ground around the base of the tree 200. The inlet fitting 50 is connected to a water supply and the fertilizer dispenser 20 is in fluid communication with the distribution hole 60 through which water infused with fertilizer exits to irrigate the base of the tree 200.

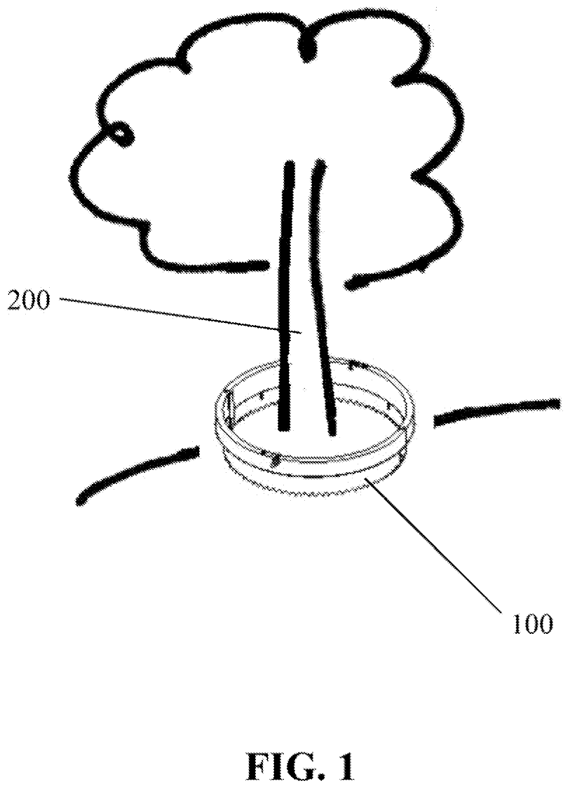

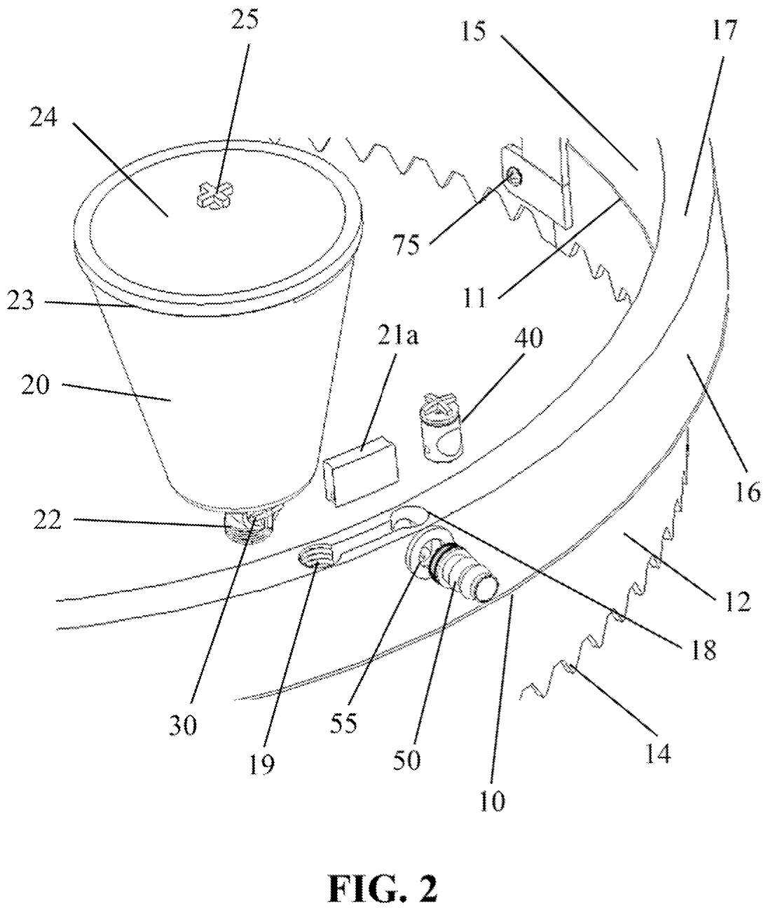

FIG. 1 shows a perspective view of the tree watering and fertilizing apparatus 100 of the present invention as it would be used around a tree 200. FIG. 2 shows an exploded view of the tree watering and fertilizing apparatus 100 of the present invention to depict in greater detail the various components that comprise the tree watering and fertilizing apparatus 100.

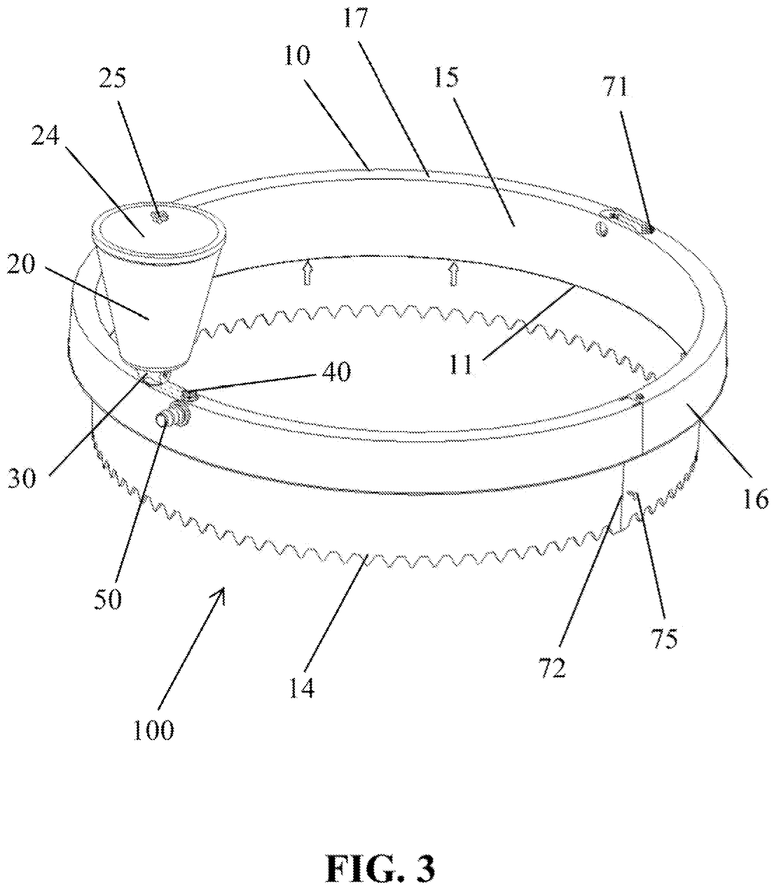

As shown in. FIG. 3, the tree ring 10 has a top section and a bottom section with a grade level line indicator 11 in between the two. The bottom section comprises a bottom barrier 12 that extends downward from said grade level line indicator 11. In addition, a plurality of ground piercing teeth 14 extend downwardly from said bottom barrier 12. The top section comprises an inner barrier 15 that extends upward from said grade level line indicator 11 and an outer barrier 16 both of which share the same center of curvature. Further, a top shelf 17 is formed between the inner barrier 15 and the outer barrier 16. A valve hole 18 and a dispenser hole 19 are located on the top shelf 17. A feed tube 21 located within the top shelf 17 connects the valve hole 18 to the dispenser hole 19. Formation of the feed tube 21 within the top shelf 17 requires a feed tube cover 21a to form part of the feed tube 21 and serve as a cover that is permanently and seal ingly attached within the top shelf 17. The top shelf 17 and the teed tube cover 21a are joined to form the feed tube 21 within the top shelf 17 connecting the valve hole 18 to the dispenser hole 19. A through hole 55 transverse to the valve hole 18 extends through the top shelf 17 The through hole 55 has an inner end and an outer end. Furthermore, an accessory hole 71 located within the top shelf 17 allows an accessory itemto be attached thereto. Finally, the tree ring 10 is formed by two half rings joined together by connectors 75 at a slit 72. Alternatively, a slit 72 severs the tree ring 10 on one side so that the tree ring 10 can be opened and wrapped around the base of a tree 200.

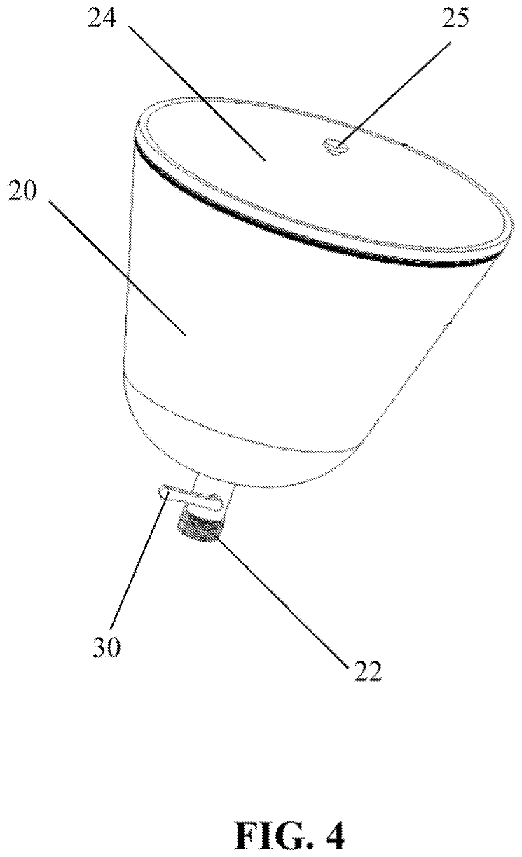

As shown in FIG. 4, the fertilizer dispenser 20 is primarily, but not always, conical in shape so as to funnel the fertilizer therein through a dispenser tube 22 to which a fertilizer valve 30 is attached. Further, the fertilizer dispenser 20 has a top opening 23 through which fertilizer is added and on which a dispenser lid 24 is placed to serve as a cover. The dispenser lid 24 has a handle 25 used to place or remove the dispenser lid 24.

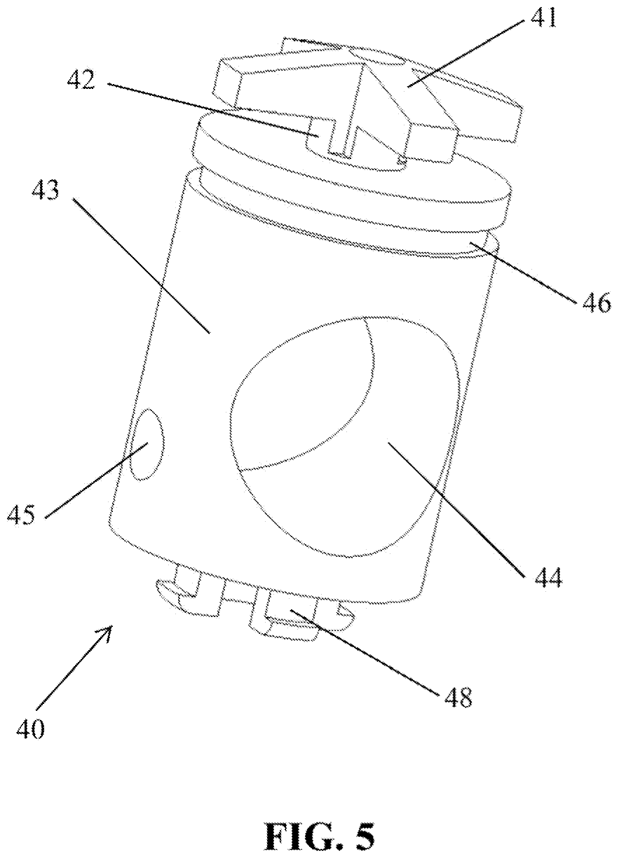

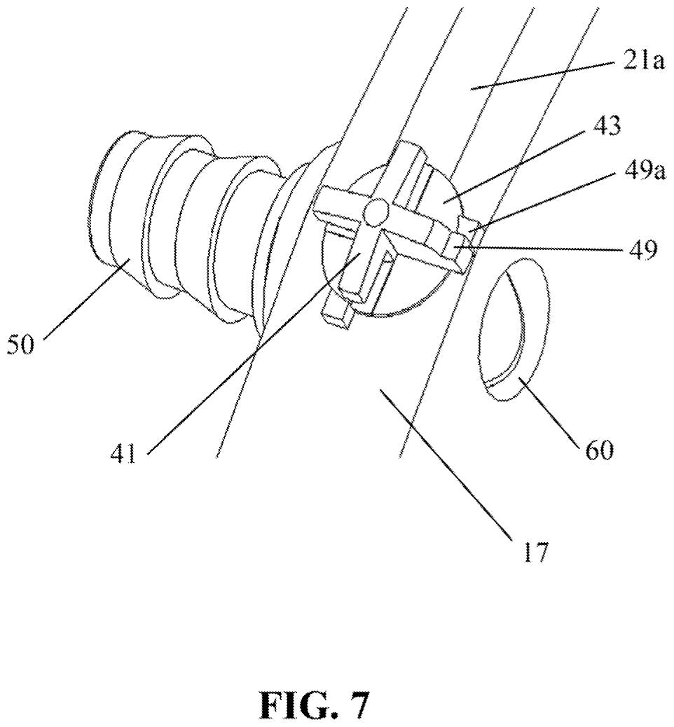

As shown in FIG. 5, the irrigation valve 40 has a handle 41 on the top resting ora stem 42 attached to a body 43 that is primarily, but not always, cylindrical in shape. The body 43 has an irrigation hole 44 that extends from one side of the body 43 through the other in a straight direction. In addition, a feed hole 45 extends within the body 43 transversely to the irrigation hole 44. The feed hole 45 has a diameter that is smaller than that of the irrigation hole 44 and the feed hole 45 extends into the irrigation hole 44. Furthermore, a first o-ring is attached to the o-ring channel 46 around the top section of the body 43 while a second o-ring is attached around the bottom section of the body 43. Further, a plurality of latching feet 48 protrude downward from the bottom face of the body 43. Finally, as shown in FIG. 7, a nub 49 extends radially outward from the handle 41 to serve as a stopper against pegs 49a on the top shelf 17 that restricts rotation of the irrigation valve 40 so that the feed hole 45 does not align with the inlet fitting 50.

Hereinafter, an explanation on the methods of assembling the product of the present invention, the installation thereof to a tree, and the operating states thereof will be given.

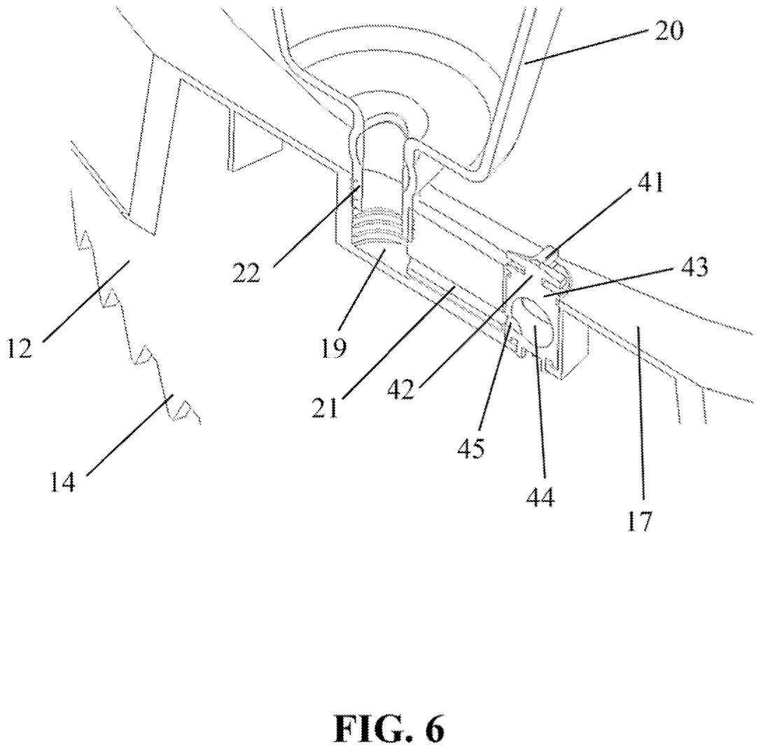

For the assembly of the tree watering and fertilizing apparatus 100 of the present invention, the tree ring 10 is placed around a tree 200, preferably concentric to the tree, at a predetermined distance from the base of the trunk of the tree. Then the tree ring 10 is pushed down until the bottom section is buried in the ground and the grade level line indicator 11 is at ground or grade level. The ground piercing teeth 14 aid in the process of digging and burying the bottom section of the tree ring 10. The ground piercing teeth 14 have edges, as shown in FIG. 6, that facilitate in the process of digging and burying the bottom section of the tree ring 10.

Once the tree ring 10 is installed around the tree 200, the inlet fitting 50 is inserted into the outer end of the the through hole 55 from the outer side of the tree ring 10. Then the irrigation valve 40 is inserted into the valve hole 18 until the irrigation hole 44 aligns with the through hole 55 and the feed hole 45 aligns with the feed tube 21. Then the inner end of the through hole 55 located in the inner side of the tree ring 10 becomes the distribution hole 60 aligned and adjacent to the irrigation hole 44. Then the fertilizer dispenser 20 is attached to the tree ring 10 by inserting the dispenser tube 22 into the dispenser hole 19. Finally, an accessory, such as a light, can be inserted into the accessory hole 71.

After the tree watering and fertilizing apparatus 100 is assembled and installed around a tree 200, a water supply hose 300 is connected to the inlet fitting 50 and the fertilizer dispenser 20 is filled with liquid fertilizer while the fertilizer valve 30 is in the off or closed position. Finally, the dispenser lid 24 is placed on the fertilizer dispenser 20 so as to serve as a lid or cover, as shown FIG. 7.

Finally, with the watering and fertilizing apparatus 100 of the present invention assembled, installed around a tree 200, and connected to a water supply 300, the water supply is turned on and the irrigation valve 40 is turned to the open or on position to allow the water flow from the inlet fitting 50 through the distribution hole 60 and around the base of the tree 200. Thereafter, the fertilizer valve 30 is turned to the open or on position so that the liquid fertilizer can flow through the dispenser tube 22 into the feed tube 21 such that the water flowing through the distribution fitting 60 siphons the liquid fertilizer and mixes it within the water flowing out around the base of the tree 200. The water and/or fertilizer being distributed on the tree 200 is controlled with the irrigation valve 40 and the fertilizer valve 30, respectively.

It is understood that the described embodiments of the present invention as discussed above are illustrative only, and that modifications thereof may occur to those skilled in the art. Accordingly, this invention is not to be regarded as limited to the embodiments disclosed, but to he limited only as defined by the appended claims herein.

What is claimed is:

1. A tree watering and fertilizing apparatus comprising:
a tree ring having a top section, a bottom harrier, a top shelf, a through hole having an outer end and an inner end, a valve hole, a dispenser hole, a distribution hole, and a feed tube within said top shelf;
a fertilizer dispenser having a top opening and a dispenser tube that is inserted into said dispenser hole:
a fertilizer valve that is connected to said dispenser tube;
an irrigation valve having a feed hole that transversely extends into an irrigation hole;
an inlet fitting that is inserted into said outer end of said through hole;
wherein said irrigation valve is inserted into said valve hole such that said irrigation hole is aligned with said outer end and said inner end of said through hole, and such that said feed hole aligns with said feed tube; and
wherein said feed tube is in fluid communication with said dispenser hole.

2. A tree watering and fertilizing apparatus of claim 1 further comprising, a plurality of teeth extending from said bottom barrier.

3. tree watering and fertilizing apparatus of claim 1 further comprising a grade level line indicator in between said top section and said bottom barrier.

4. A tree watering and fertilizing apparatus of claim 1 further comprising an accessory hole.

5. A tree watering and fertilizing apparatus of claim 1 wherein said irrigation valve further comprises a top section to which a handle is attached.

6. A tree watering and fertilizing apparatus of claim 1 wherein said irrigation valve further comprises a bottom face from which a plurality of latching feet extend.

7. A tree watering and fertilizing apparatus of claim 1 wherein said irrigation valve can be rotated within said valve hole so as to align said irrigation hole with said outer end and said inner end of said through hole.

8. A tree watering and fertilizing apparatus of claim 1 wherein said fertilizer dispenser further comprises a dispenser lid.
